(19) United States
(12) Patent Application Publication
(10) Pub. No.: US 2022/0235215 A1
(43) Pub. Date: Jul. 28, 2022

(54) AQUEOUS DISPERSION AND AQUEOUS COATING COMPOSITION COMPRISING THE SAME

(71) Applicants: Dow Global Technologies LLC, Midland, MI (US); Rohm and Haas Company, Collegeville, PA (US); Dow Silicones Corporation, Midland, MI (US)

(72) Inventors: Wenke Miao, Shanghai (CN); Yuehan Hu, Shanghai (CN); Tao Wang, Shanghai (CN); Caifeng Wang, Shanghai (CN); Xiangting Dong, Shanghai (CN); Shaoguang Feng, Shanghai (CN); Zhihua Liu, Shanghai (CN)

(21) Appl. No.: 17/612,255

(22) PCT Filed: Jul. 1, 2019
(86) PCT No.: PCT/CN2019/094185

§ 371 Date: Nov. 18, 2021

(51) Int. Cl. C08L 33/08; C08G 77/16; C08G 77/20; C08K 5/132; C09D 5/02

(52) U.S. Cl. CPC C08L 33/08; C08G 77/16; C08G 77/20; C08G 2150/00; C09D 5/022; C08L 2201/52; C08L 2201/54; C08K 5/132

(57) ABSTRACT

A stable aqueous dispersion comprising an emulsion polymer and a specific amount of a linear siloxane, a cyclic siloxane, or mixtures thereof; an aqueous coating composition comprising the aqueous dispersion providing coatings with improved dirt pick-up resistance and long-term durability.

### FIELD OF THE INVENTION

The present invention relates to an aqueous dispersion and an aqueous coating composition comprising the same.

### INTRODUCTION

In exterior coating applications, dirt pick-up resistance (DPUR) is a key property to enable coatings to maintain color and gloss upon exposure to the elements such as sunlight. Inorganic pigments such as TiO₂, a commonly used white pigment for paints, when exposed to sunlight, may adversely affect coating durability.

Incorporation of photocrosslinkers into coatings is one of commonly used approaches to improve DPUR properties in the coating industry, due to their high efficiency to generate free radicals under sunlight and increase surface hardness of coating films. The most widely used photocrosslinkers in coatings include derivatives of benzophenones (BzP), benzotriazoles (BT), triazines (TA), and oxanilides (OA). However, free radicals generated by these photocrosslinkers cause degradation of polymers which will hurt long-term durability. It is therefore desirable to provide an aqueous polymer dispersion suitable for coating applications that provides exterior coatings, for example, elastomeric wall coatings, with improved dirt pick-up resistance and long-term durability.

### SUMMARY OF THE INVENTION

The present invention provides an aqueous dispersion comprising an admixture of an emulsion polymer with a specific amount of a linear siloxane with formula (I), a cyclic siloxane with formula (II), or a mixture of the linear siloxane and the cyclic siloxane. The aqueous dispersion of the present invention is storage stable. An aqueous coating composition comprising such aqueous dispersion can provide coatings made therefrom with improved dirt pick-up resistance and long-term durability as determined by the test methods described in the Examples section below.

In a first aspect, the present invention is an aqueous dispersion comprising:

(a) an emulsion polymer,

(b) from 0.1% to 5.5% of a siloxane selected from a linear siloxane, a cyclic siloxane, and mixtures thereof, by weight based on the dry weight of the emulsion polymer, wherein the linear siloxane has the following formula (I),

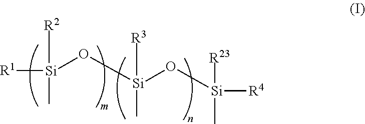

where R¹ and R⁴ are independently selected from —OH, —NH₂, —NHR⁵, and —NR⁵₂, wherein each R⁵ is independently a C₁₋₅ alkyl group; each R² is independently a C₂₋₁₀ linear or branched alkenyl group with one to three double bonds; each R³ is independently selected from a C₁₋₆ linear or branched alkyl group; R²³ is a C₂₋₁₀ linear or branched alkenyl group with one to three double bonds or a C₁₋₆ linear or branched alkyl group; m is an integer of from 2 to 40; and n is an integer of from 0 to 20;

wherein the cyclic siloxane has the following formula (II),

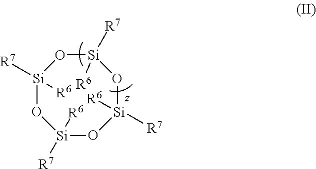

where each R⁶ is independently selected from hydrogen and a C₁₋₆ linear or branched alkyl group; each R⁷ is independently a C₂₋₁₀ linear or branched alkenyl group with one to three double bonds; and z is an integer of from 1 to 20; and

(c) from zero to 3% of a photocrosslinker, by weight based on the dry weight of the emulsion polymer.

In a second aspect, the present invention is a process of preparing the aqueous dispersion of the first aspect. The process comprises:

admixing an emulsion polymer with from 0.1% to 5.5% of a siloxane selected from a linear siloxane, a cyclic siloxane, and mixtures thereof, and from zero to 3% of a photocrosslinker, by weight based on the dry weight of the emulsion polymer;

wherein the linear siloxane has the following formula (I),

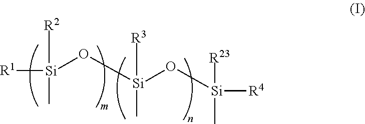

where R¹ and R⁴ are independently selected from —OH, —NH₂, —NHR⁵, and —NR⁵₂, wherein each R⁵ is independently a C₁₋₅ alkyl group; each R² is independently a C₂₋₁₀ linear or branched alkenyl group with one to three double bonds; each R³ is independently a C₁₋₆ linear or branched alkyl group; R²³ is a C₂₋₁₀ linear or branched alkenyl group with one to three double bonds or a C₁₋₆ linear or branched alkyl group; m is an integer of from 2 to 40; and n is an integer of from 0 to 20;

wherein the cyclic siloxane has the following formula (II),

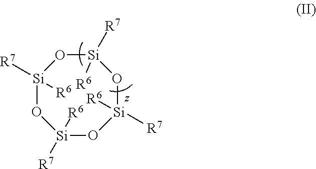

where each R⁶ is independently selected from hydrogen and a C₁₋₆ linear or branched alkyl group; each R⁷ is independently a C₂₋₁₀ linear or branched alkenyl group with one to three double bonds, and z is an integer of from 1 to 20.

In a third aspect, the present invention is an aqueous coating composition comprising the aqueous dispersion of the first aspect and a pigment and/or an extender.

### DETAILED DESCRIPTION OF THE INVENTION

“Aqueous” dispersion herein means that particles dispersed in an aqueous medium. By “aqueous medium” herein is meant water and from zero to 30%, by weight based on the weight of the medium, of water-miscible compound(s) such as, for example, alcohols, glycols, glycol ethers, glycol esters, and the like.

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

As used herein, the term structural units, also known as polymerized units, of the named monomer refers to the remnant of the monomer after polymerization. For example, a structural unit of methyl methacrylate is as illustrated:

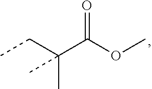

where the dotted lines represent the points of attachment of the structural unit to the polymer backbone.

The aqueous dispersion of the present invention comprises one or more siloxanes selected from a linear siloxane, a cyclic siloxane, and mixtures thereof. The aqueous dispersion may comprise one or more linear siloxanes having the following formula (I),

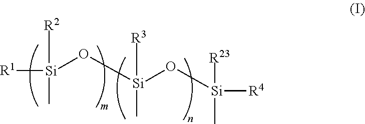

where R¹ and R⁴ are each independently selected from —OH, —NH₂, —NHR⁵, and —NR⁵₂, wherein each R⁵ is independently a C₁₋₅ alkyl group; each R² is independently a C₂₋₁₀ linear or branched alkenyl group with one to three double bonds (i.e., C═C bonds); each R³ is independently a C₁₋₆ linear or branched alkyl group; R²³ is a C₂₋₁₀ linear or branched alkenyl group with one to three double bonds or a C₁₋₆ linear or branched alkyl group; m is an integer of from 2 to 40; and n is an integer of from 0 to 20. The term “alkenyl group” herein refers to a monovalent hydrocarbon group formed from an alkene by removal of one hydrogen atoms from any carbon atom. R¹ and R⁴ may be the same or different. Preferably, R¹ and R⁴ are independently selected from —OH and —NH₂. More preferably, R¹ and R⁴ are both —OH. R² groups may be the same or different. Each R² may independently have from 2 to 10, from 2 to 8, from 2 to 7, from 2 to 6, or from 2 to 5 of carbon atoms. Preferably, R² contains one vinyl group. More preferably, R² is —CH═CH₂; R³ groups may be the same or different. Preferably, each R³ is the same and selected from —CH₃ and —C₂H₅. m can be in the range of from 2 to 40, from 3 to 30, from 4 to 20, from 4 to 16, from 5 to 15, from 6 to 12, or from 8 to 12. n can be in the range of from 0 to 20, from 0 to 10, from 0 to 6, from 0 to 4, or from 0 to 3. The linear siloxane can be a random copolymer, a block copolymer, or a homopolymer.

The aqueous dispersion of the present invention may comprise one or more cyclic siloxanes having the following formula (II),

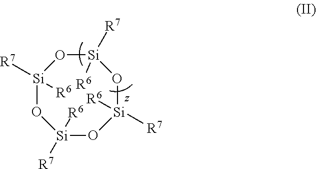

where each R⁶ is independently selected from hydrogen and a C₁₋₆ linear or branched alkyl group such as, for example, —CH₃ and —C₂H₅; each R⁷ is independently a C₂₋₁₀ linear or branched alkenyl group with one to three double bonds (i.e., C═C bonds), preferably containing one vinyl group, more preferably, R⁷ is —CH═CH₂; and z is an integer of from 1 to 20, from 1 to 15, from 1 to 10, from 1 to 7, from 1 to 6, from 1 to 5, or from 1 to 4. R⁶ groups may be the same or different. Preferably, each R⁶ is the same and selected from —CH₃ and —C₂H₅. R⁷ groups may be the same or different. Preferably, each R⁷ is independently selected from ethylenyl (—CH═CH₂), propylenyl, butylenyl, and pentenyl. More preferably, each R⁷ is independently selected from ethylenyl and propylenyl. Suitable cyclic siloxanes may include, for example, tetramethyltetravinylcyclotetrasiloxane, tetraethyltetravinylcyclotetrasiloxane, tetrapropyltetravinylcyclotetrasiloxane, tetrabutyltetravinylcyclotetrasiloxane, tetrahexyltetravinylcyclotetrasiloxane, or mixtures thereof. The aqueous dispersion of the present invention may comprise a combination of one or more linear siloxanes and one or more cyclic siloxanes.

The siloxane in the aqueous dispersion may be present, by weight based on the dry weight of the emulsion polymer, in a combined amount of from 0.1% to 5.5%, for example, 0.1% or more, 0.2% or more, 0.3% or more, 0.4% or more, 0.5% or more, 0.6% or more, 0.7% or more, 0.8% or more, 0.9% or more, 1.0% or more, 1.1% or more, 1.2% or more, 1.3% or more, 1.4% or more, or even 1.5% or more, and at the same time, 5.5% or less, 5.2% or less, 5% or less, 4.7% or less, 4.5% or less, 4.2% or less, 4% or less, 3.7% or less, 3.5% or less, 3.2% or less, 3% or less, 2.8% or less, 2.5% or less, 2.2 or less, or even 2% or less.

The aqueous dispersion of the present invention comprises one or more emulsion polymers. The emulsion polymer may comprise structural units of one or more monoethylenically unsaturated ionic monomers. The term “ionic monomers” herein refers to monomers that bear an ionic charge between pH=1-14. The monoethylenically unsaturated ionic monomers may include α, β-ethylenically unsaturated carboxylic acids and/or their anhydrides, for example, (meth)acrylic anhydride, maleic anhydride, or mixtures thereof; phosphorous acid monomers and/or salts thereof, sulfonate monomers such as sodium styrene sulfonate (SSS) and sodium vinyl sulfonate (SVS), acrylamido-2-methylpropanesulfonic acid (AMPS), sodium acrylamido-2-methylpropanesulfonic acid; or mixtures thereof. Suitable α, β-ethylenically unsaturated carboxylic acids may include, for example, acrylic acid, methyl acrylic acid, crotonic acid, acyloxypropionic acid, maleic acid, fumaric acid, itaconic acid, or mixtures thereof. The phosphorous acid monomers can be dihydrogen phosphate esters of an alcohol in which the alcohol contains or is substituted with a polymerizable vinyl or olefinic group. Suitable monoethylenically unsaturated phosphorous acid monomers and salts thereof may include phosphoalkyl (meth)acrylates such as phosphoethyl (meth)acrylate, phosphopropyl (meth)acrylate, phosphobutyl (meth)acrylate, salts thereof, or mixtures thereof; CH₂═C(R)—C(O)—O—(RₚO)ₚ—P(O)(OH)₂, wherein R═H or CH₃, Rₚ=alkyl and p=1-10, such as SIPOMER PAM-100, SIPOMER PAM-200, and SIPOMER PAM-300 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, salts thereof, and mixtures thereof. Preferred monoethylenically unsaturated ionic monomers are selected from the group consisting of acrylic acid, methacrylic acid, sodium styrene sulfonate, phosphoethyl methacrylate (PEM), or mixtures thereof. The emulsion polymer may comprise by weight based on the dry weight of the emulsion polymer, 0.05% or more, 0.1% or more, 0.3% or more, 0.5% or more, or even 1% or more, and at the same time, 15% or less, 10% or less, 8% or less, 5% or less, 4% or less, or even 3% or less of structural units of the monoethylenically unsaturated ionic monomer.

The emulsion polymer useful in the present invention may comprise structural units of one or more monoethylenically unsaturated nonionic monomers. “Nonionic monomers” herein refers to monomers that do not bear an ionic charge between pH=1-14. The monoethylenically unsaturated nonionic monomers may include C₁-C₂₀, C₁-C₁₀, or C₁-C₈-alkyl esters of (meth)acrylic acid. Examples of suitable monoethylenically unsaturated nonionic monomers include methyl acrylate, methyl methacrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate, or combinations thereof; (meth)acrylamide; (meth)acrylonitrile; ureido-functional monomers such as hydroxyethyl ethylene urea methacrylate; cycloalkyl (meth)acrylates such as cyclohexyl(meth)acrylate, methcyclohexyl acrylate, isobornyl methacrylate, isobornyl acrylate, and dihydrodicyclopentadienyl acrylate; monomers bearing acetoacetate-functional groups such as acetoacetoxyethyl methacrylate (AAEM); monomers bearing carbonyl-containing groups such as diacetone acrylamide (DAAM); vinyl aromatic monomers including styrene and substituted styrene such as .alpha.-methyl styrene, p-methyl styrene, t-butyl styrene, vinyltoluene, or mixtures thereof; vinyltrialkoxysilanes such as vinyltrimethoxysilane, vinyltriethoxysilane, and vinyltris(2-methoxyethoxy)silane, vinyldimethylethoxysilane, vinylmethyldiethoxysilane, and (meth)acryloxyalkyltrialkoxysilanes such as (meth)acryloxyethyltrimethoxysilane and (meth)acryloxypropyltrimethoxysilane; butadiene; α-olefins such as ethylene, propylene, and 1-decene; vinyl acetate, vinyl butyrate, vinyl versatate and other vinyl esters; glycidyl (meth)acrylate; or combinations thereof. Preferred monoethylenically unsaturated nonionic monomers are selected from the group consisting of methyl methacrylate, ethyl acrylate, butyl acrylate, 2-ethylhexyl acrylate, styrene, and mixtures thereof. The emulsion polymer may comprise, by weight based on the weight of the emulsion polymer, 50% or more, 60% or more, 70% or more, or even 80% or more, and at the same time, 99% or less, 98% or less, 95% or less, 90% or less, or even 85% or less of structural units of the monoethylenically unsaturated nonionic monomers.

The emulsion polymer useful in the present invention may optionally comprise structural units of one or more multiethylenically unsaturated monomers including di-, tri-, tetra-, or higher multifunctional ethylenically unsaturated monomers. Suitable multiethylenically unsaturated monomers may include, for example, butadiene, allyl (meth)acrylate, diallyl phthalate, divinyl benzene, ethylene glycol dimethacrylate, butylene glycol dimethacrylate, or mixtures thereof. The emulsion polymer may comprise, by weight based on the weight of the emulsion polymer, in an amount of from zero to 5%, from 0.05% to 1%, or from 0.1% to 0.5% of structural units of the multiethylenically unsaturated monomer.

Types and levels of the monomers described above may be chosen to provide the emulsion polymer with a glass transition temperature (Tg) suitable for different applications, for example, in the range of from −40° C. to 50° C., from −35° C. to 35° C., from −30° C. to 25° C., or from −25° C. to 10° C. Tg may be measured by Differential Scanning Calorimetry (DSC) as described in the Examples section below.

The emulsion polymer particles in the aqueous dispersion may have a particle size of from 50 nanometers (nm) to 500 nm, from 80 to 400 nm, from 90 to 300 nm, or 100 to 200 nm. The particle size herein refers to Z-average size and may be measured by a Brookhaven BI-90 Plus Particle Size Analyzer.

The emulsion polymer in the aqueous dispersion may be prepared by emulsion polymerization of the monomers described above. Monomers for preparing the emulsion polymer are those monomers described above that are used for forming structural units the emulsion polymer. Total weight concentration of monomers for preparing the emulsion polymer is equal to 100%. The weight content of each monomer based on the total weight of monomers for preparing the emulsion polymer may be substantially the same as the weight content of structural units of such monomer based on the dry weight of the emulsion polymer. The polymerization techniques used to prepare the emulsion polymer are well known in the art. A mixture of monomers may be added neat or as an emulsion in water; or added in one or more additions or continuously, linearly or nonlinearly, over the reaction period of preparing the emulsion polymer. Temperature suitable for emulsion polymerization processes may be lower than 100° C., in the range of from 30 to 98° C., or in the range of from 50 to 95° C. Multistage free-radical polymerization using the monomers described above can be used, which at least two stages are formed sequentially, and usually results in the formation of the multistage polymer comprising at least two polymer compositions.

One or more surfactants may be used in the polymerization process of preparing the emulsion polymer. The surfactant may be added prior to or during the polymerization of the monomers, or combinations thereof. A portion of the surfactant can also be added after the polymerization. These surfactants may include anionic and/or nonionic surfactants. Examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. In some preferred embodiments, nonionic surfactants are used. Commercially available nonionic surfactants may include, for example, TERGITOL™ 15-s-40, 15-s-15, TMN-6, and CA-90 secondary alcohol ethoxylates, ECOSURF™ EH-9 and EH-14 secondary alcohol ethoxylates, and TRITON™ X-405 and HW 1000 octylphenol ethoxylates all available from The Dow Chemical Company (TERGITOL, ECOSURF, and TRITON are all trademarks of The Dow Chemical Company), or mixtures thereof. The surfactant is usually used in an amount of from 0.1% to 5%, from 0.15% to 4%, from 0.2% to 3%, or from 0.2% to 2%, by weight based on the total weight of monomers used for preparing the emulsion polymer.

In the polymerization process of preparing the emulsion polymer, one or more chain transfer agents may be used. Examples of suitable chain transfer agents include n-dodecylmercaptan (nDDM), and 3-mercaptopropionic acid, methyl 3-mercaptopropionate (MMP), butyl 3-mercaptopropionate (BMP), benzenethiol, azelaic alkyl mercaptan, or mixtures thereof. The chain transfer agent may be used in an effective amount to control the molecular weight of the emulsion polymer. Preferably, the chain transfer agent is used in an amount of 0.01% or more, 0.05% or more, or even 0.1% or more, and at the same time, 2% or less, 1% or less, or even 0.5% or less, by weight based on the total weight of monomers used for preparing the emulsion polymer.

In the polymerization process of preparing the emulsion polymer, free radical initiators may be used. The polymerization process may be thermally initiated or redox initiated emulsion polymerization. Examples of suitable free radical initiators include hydrogen peroxide, t-butyl hydroperoxide, cumene hydroperoxide, ammonium and/or alkali metal persulfates, sodium perborate, perphosphoric acid, and salts thereof; potassium permanganate, and ammonium or alkali metal salts of peroxydisulfuric acid. The free radical initiators may be used typically at a level of from 0.1% to 5% or from 0.3% to 3%, by weight based on the total weight of monomers. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Metal salts of iron, copper, manganese, silver, platinum, vanadium, nickel, chromium, palladium, or cobalt may be used to catalyze the redox reaction. Chelating agents for the metals may optionally be used.

After completing the polymerization of the emulsion polymer, the obtained emulsion polymer may be neutralized by one or more bases as neutralizers to a pH value, for example, at least 6, from 6 to 10, or from 7 to 9. The bases may lead to partial or complete neutralization of the ionic or latently ionic groups of the emulsion polymer. Examples of suitable bases include ammonia; alkali metal or alkaline earth metal compounds such as sodium hydroxide, potassium hydroxide, calcium hydroxide, zinc oxide, magnesium oxide, sodium carbonate; primary, secondary, and tertiary amines, such as triethyl amine, ethylamine, propylamine, monoisopropylamine, monobutylamine, hexylamine, ethanolamine, diethyl amine, dimethyl amine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, polyethyleneimine or polyvinylamine; aluminum hydroxide; or mixtures thereof.

The aqueous dispersion of the present invention may comprise one or more nonionic surfactants. Suitable nonionic surfactants include those described above in the polymerization process of preparing the emulsion polymer section above. The nonionic surfactant may be present in an amount of from zero to 5%, from 0.1% to 5%, from 0.15% to 4%, from 0.2% to 3%, or from 0.2% to 2%, by weight based on the dry weight of the emulsion polymer.

The aqueous dispersion of the present invention may further comprise one or more photocrosslinkers. The photocrosslinkers useful in the present invention may include benzophenone (BP) derivatives, benzotriazole (BTA) derivatives, acylphosphine oxides, bisacylphosphine oxides, or mixtures thereof.

Suitable benzophenone derivatives may include benzophenone derivatives with one or both of the phenyl rings being substituted, for example, benzophenone, 4-methyl benzophenone, 4-hydroxy benzophenone, 4-amino benzophenone, 4-chloro benzophenone, 4-hydrocarboxyl benzophenone, 4,4′-dimethyl benzophenone, 4,4′-dichloro benzophenone, 4-carboxymethyl benzophenone, 3-nitro benzophenone, or mixtures thereof. Preferred benzophenone derivative is benzophenone or a 4-substituted (para-) benzophenone. Benzophenone is more preferred.

Suitable benzotriazole derivatives may include, for example, 1,2-(2′-hydroxyphenyl)benzotriazoles such as 2-(2′-hydroxy-5′-methylphenyl)benzotriazole, 2-(3′,5′-di-tert-butyl-2′-hydroxyphenyl) benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphen-yl)-5-chlorobenzotriazole, 2-(3′-sec-butyl-5′-tert-butyl-2′-hydroxyphenyl)benzotriazole, 2-(2′-hydroxy-4′-octoxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)-benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethyl-hexyl-oxy)carbonylethyl]-2′-hydroxyphenyl)-5-chlorobenzotriazole, 2-(3′-tert-butyl-2′-hy-droxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxy-carbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazol-2-yl-phenol]; transesterification product of 2-[3′-tert-butyl-5′-(2-methoxycarbonylethyl)-2′-hydroxy-phenyl]-benzotriazole with polyethylene glycol 300; [R—CH₂—CH₂—COO(CH₂)₃]₂, where R=3′-tert-butyl-4′-hydroxy-5′-2H-benzotriazol-2-yl-phenyl, or mixtures thereof.

Suitable acylphosphine oxides may include, for example, 2,6-dimethylbenzoyldiphenyl phosphine oxide, 2,4,6-trimethylbenzoyldiphenylphosphine oxide, bis(2,4,6-trimethylbenzoyl)phenyl phosphine oxide, 2,6-dichlorobenzoyl-diphenylphosphine oxide, and 2,6-dimethoxybenzoyldiphenylphosphine oxide, or mixtures thereof.

Suitable bisacylphosphine oxides may include, for example, bis(2,6-dimethyoxybenzoyl)-2,4,4-trimethylepentylphosphine oxide, bis(2,6-dimethylbenzoyl)-2,4,4-trimethylpentylphosphine oxide, bis (2,4,6-trimethylbenzoyl)-2,4,4-trimethylpentylphosphine oxide, and bis(2,6-dichlorobenzoyl)-2,4,4-trimethylpentylphosphine oxide, or mixtures thereof.

The photocrosslinker useful in the present invention may be present, by weight based on the dry weight of the emulsion polymer, in an amount of from zero to 3%, for example, 0.01% or more, 0.02% or more, 0.03% or more, 0.04% or more, 0.05% or more, 0.06% or more, 0.07% or more, 0.08% or more, 0.09% or more, 0.10% or more, 0.12% or more, 0.15% or more, 0.18% or more, or even 0.20% or more, and at the same time, 3.0% or less, 2.8% or less, 2.5% or less, 2.2% or less, 2.0% or less, 1.8% or less, 1.5% or less, 1.4% or less, 1.3% or less, 1.2% or less, 1.1% or less, 1.0% or less, 0.9% or less, 0.8% or less, 0.7% or less, 0.6% or less, or even 0.5% or less. In some embodiments, the aqueous dispersion of the present invention is substantially free of the photocrosslinker (i.e., less than 0.01%, preferably zero), while still achieving satisfactory DPUR properties.

The aqueous dispersion of the present invention further comprises water. The concentration of water may be, by weight based on the total weight of the aqueous dispersion, from 30% to 90% or from 40% to 80%. The aqueous dispersion of the present invention may be useful as binders in many applications including, for example, wood coatings, architecture coatings, metal coatings, and traffic paints.

The aqueous dispersion of the present invention may be prepared by admixing the emulsion polymer with the siloxane, and optionally, the photocrosslinker, the nonionic surfactant, and other optional components. The present invention also relates to a process of preparing the aqueous dispersion by admixing the emulsion polymer with the siloxane, and optionally, the photocrosslinker. The aqueous dispersion of the present invention is a stable aqueous dispersion with no significant phase separation (i.e., no significant layering) after storage at 50° C. for 28 days, as determined according to the test method described above.

The present invention also relates to an aqueous coating composition comprising the aqueous dispersion of the present invention. The aqueous coating composition may comprise, by dry weight based on the total dry weight of the aqueous coating composition, from 20% to 99.5%, from 30% to 98%, or from 35% to 95%, of the aqueous polymer dispersion.

The aqueous coating composition of the present invention may further comprise pigments. “Pigment” herein refers to a particulate inorganic material which is capable of materially contributing to the opacity or hiding capability of a coating. Such materials typically have a refractive index greater than 1.8. Inorganic pigments may include, for example, titanium dioxide (TiO₂), zinc oxide, iron oxide, zinc sulfide, barium sulfate, barium carbonate, or mixture thereof. In a preferred embodiment, pigment used in the present invention is TiO₂. TiO₂ typically exists in two crystal forms, anastase and rutile. TiO₂ may be also available in concentrated dispersion form. The aqueous coating composition may also comprise one or more extenders. “Extender” herein refers to a particulate inorganic material having a refractive index of less than or equal to 1.8 and greater than 1.3. Examples of suitable extenders include calcium carbonate, clay, calcium sulfate, aluminosilicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The aqueous coating composition may have a pigment volume concentration (PVC) of from 8% to 70%, from 12% to 60%, or from 15% to 55%. PVC may be determined by the equation: PVC=[Volume_{(Pigment+Extender)}/Volume_{(Pigment+Extender+Binder)}]×100%.

The aqueous coating composition of the present invention may further comprise one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from TEGO, BYK-024 silicone deformer available from BYK, or mixtures thereof. The defoamer may be present, by weight based on the total dry weight of the aqueous coating composition, in an amount of from zero to 2%, from 0.1% to 1.5%, or from 0.2% to 1%.

The aqueous coating composition of the present invention may further comprise one or more thickeners. The thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferably, the thickener is a hydrophobically-modified hydroxy ethyl cellulose (HMHEC). The concentration of the thickener may be present, by dry weight based on the total dry weight of the aqueous coating composition, in an amount of from zero to 4%, from 0.2% to 3%, or from 0.4% to 2%.

The aqueous coating composition of the present invention may further comprise one or more wetting agents. “Wetting agents” herein refer to chemical additives that reduce the surface tension of a coating composition, causing the coating composition to more easily spread across or penetrate the surface of a substrate. Wetting agents may be polycarboxylates, anionic, zwitterionic, or non-ionic. The wetting agent may be present, by weight based on the total dry weight of the aqueous coating composition, in an amount of from zero to 3%, from 0.1% to 2.5%, or from 0.2% to 2%.

The aqueous coating composition of the present invention may further comprise one or more dispersants. The dispersants may include nonionic, anionic, or cationic dispersants such as polyacids with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. The polyacids used may include homopolymers and copolymers based on polycarboxylic acids (e.g., weight average molecular weight ranging from 1,000 to less than 50,000 as measured by gel permeation chromatography (GPC)), including those that have been hydrophobically- or hydrophilically-modified, e.g., polyacrylic acid or polymethacrylic acid or maleic anhydride with various monomers such as styrene, acrylate or methacrylate esters, diisobutylene, and other hydrophilic or hydrophobic comonomers; salts of thereof; or mixtures thereof. The dispersant may be present, by dry weight based on the total dry weight of the aqueous coating composition, in an amount of from zero to 3%, from 0.1% to 2%, from 0.2% to 1.5%, or from 0.3% to 1.2%.

The aqueous coating composition of the present invention may further comprise one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The coalescent may be present, by weight based on the total dry weight of the aqueous coating composition, in an amount of from zero to 30%, from 0.1% to 20%, or from 0.5% to 15%.

In addition to the components described above, the aqueous coating composition of the present invention may further comprise any one or combination of the following additives: buffers, neutralizers, anti-freezing agents, humectants, mildewcides, biocides, anti-skinning agents, colorants, flowing agents, anti-oxidants, plasticizers, leveling agents, thixotropic agents, adhesion promoters, and grind vehicles. These additives may be present in a combined amount of from zero to 5%, from 0.1% to 4%, or from 0.5% to 3%, by weight based on the dry weight of the aqueous coating composition.

The aqueous coating composition of the present invention may be prepared by admixing the aqueous dispersion with other optional components, e.g., pigments and/or extenders as described above. Components in the aqueous coating composition may be mixed in any order to provide the aqueous coating composition of the present invention. Any of the above-mentioned optional components may also be added to the composition during or prior to the mixing to form the aqueous coating composition. When the aqueous coating composition comprises pigment and/or extender, that is, a pigment formulation, the pigments and/or extenders are preferably mixed with the aqueous polymer dispersion as a dispersant to form a slurry of pigments and/or extender. The obtained admixture may be then subjected to shearing in a grinding or milling device as is well known in the pigment dispersion art. Such grinding or milling devices include roller mills, ball mills, bead mills, attrittor mills and include mills in which the admixture is continuously recirculated. The shearing of the admixture is continued for a time sufficient to disperse the pigment. The time sufficient to disperse the pigment typically depends on the nature of the pigment and the aqueous polymer dispersion as a dispersant and the grinding or milling device which is used and will be determined by the skilled practitioner.

The present invention also relates to a process for using the aqueous coating composition of the present invention. The process may comprise the following: applying the aqueous coating composition to a substrate, and drying, or allowing to dry, the applied aqueous coating composition. The present invention also relates to a method of producing a coating on a substrate, comprising: applying the substrate the aqueous coating composition of the present invention, and drying, or allowing to dry the aqueous coating composition to form the coating with improved dirt pick-up resistance (DPUR) as described above. “Improved DPUR” herein means that the aqueous coating composition of the present invention provides coatings with smaller ΔY values than the same coating composition in the absence of the siloxane described above (“Conventional Coating Composition”), for example, a ΔY value of at least 1.4% lower, at least 2% lower, at least 4% lower, at least 5% lower, or at least 6% lower than that of the Conventional Coating Composition. The aqueous coating composition of the present invention can also provide better durability than the Conventional Coating Composition, for example, as indicated by a delta E value of at least 3 lower than that of the Conventional Coating Composition, after at least 9 months of outdoor exposure. DPUR and durability properties may be measured according to the test methods described in the Examples section below.

The aqueous coating composition of the present invention can be applied to, and adhered to, various substrates. Examples of suitable substrates include wood, metals, plastics, foams, stones, elastomeric substrates, glass, fabrics, concrete, or cementitious substrates. The coating composition, preferably comprising the pigment, is suitable for various applications such as marine and protective coatings, automotive coatings, traffic paint, Exterior Insulation and Finish Systems (EIFS), roof mastic, wood coatings, coil coatings, plastic coatings, powder coatings, can coatings, architectural coatings, and civil engineering coatings. The coating composition is particularly suitable for architectural coatings.

The aqueous coating composition of the present invention can be applied to a substrate by incumbent means including brushing, dipping, rolling and spraying. The aqueous composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the coating composition of the present invention has been applied to a substrate, the coating composition can dry, or allow to dry, to form a film (this is, coating) at room temperature (20-25° C.), or at an elevated temperature, for example, from 35° C. to 80° C.

### EXAMPLES

Some embodiments of the invention will now be described in the following Examples, wherein all parts and percentages are by weight unless otherwise specified.

Hydroxy-terminated methylvinyl siloxane (HO-D^{ViMe}ₘ-OH), available from The Dow Chemical Company, has the structure of

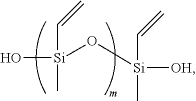

where m is 8-12.

Tetra(dimethylvinylsiloxy)silane (QM^{Vi}₄) is available from The Dow Chemical Company.

Cyclic methylvinyl siloxane (Cyclic D^{ViMe}₄), available from The Dow Chemical Company, is tetramethyltetravinylcyclotetrasiloxane.

Methylvinyl siloxane, available from The Dow Chemical Company, has the structure of

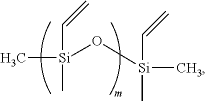

where m is 8-12.

Benzophenone (BzP), available from Sinopharm Chemical Reagent Co., Ltd., has the below structure:

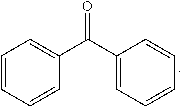 [SMILES: O=C(c1ccccc1)c1ccccc1]

The following standard analytical equipment and methods are used in the Examples.

### Preparation of Paint Panels

Paint panels were prepared according to the following procedure:

(i) an exterior primer with the composition as shown in Table 3 below was applied onto a cement panel by a roller with wet loading of 120 g/m² and cured in a constant temperature room (CTR) (25° C. and 50% relative humidity (RH)) for 2 hours;

(ii) a coating composition to be tested was brushed onto the above primer coated panel obtained from step (i) with wet loading of 200 grams per square meter (g/m²), and then cured in the CTR (25° C. and 50% RH) for 2 hours;

(iii) a second layer of the coating composition to be tested was brushed onto the panel obtained from step (ii) with wet loading of 200 g/m²; and

(iv) the obtained paint panel was cured in the CTR (25° C. and 50% RH) for 7 days before conducting the following lab DPUR and outdoor DPUR tests for white paints and durability tests for blue paints according to the below procedures.

### Lab Dirt Pick-Up Resistance (DPUR) Test

White paint panels were prepared according to the above steps (i) to (iv), based on white coating compositions described below. The paint panels were evaluated according to GB/T 9780-2013 (Test Method for Dirt Pickup Resistance and Stain Removal of Film of Architectural Coatings and Paint). The panels were irradiated by an ultraviolet light (wavelength: 360 nm) for 4 hours, and the initial reflectance value, denoted as Y*ᵢₙᵢₜᵢₐₗ, was measured. Formulated ash (0.7±0.1 g, 52.6% by weight, YouTu Instrument Company, China) was mixed with water and then brushed on the paint panels. The panels were dried for 2 hours in a CTR (25° C. and 50% RH), and then washed by water in maximum flow evenly for 1 minute and dried overnight. Then, applying ash, drying for 2 hours, washing off the ash and drying overnight in the CTR constituted one cycle and was repeated for 5 times. The final reflectance value, denoted as Y*_{final}, was measured.

### Outdoor DPUR Test

White paint panels were prepared according to the above steps (i) to (iv), based on white coating compositions described below. Initial Y* values of the paint panels were measured. These white paint panels were then subjected to outdoor exposure. The exposure direction was 450 south angle. After 9 months of exposure, appearance change of the panels was observed and final Y* values were recorded as Y*_{final}.

For the above lab DPUR and outdoor DPUR tests, Y*ᵢₙᵢₜᵢₐₗ and Y*_{final} values were measured by a Spectro-guide Sphere Gloss Portable Spectrophotometers (BYK-Gardner). The reflection Y change ratio, denoted as ΔY (%), for lab DPUR and outdoor DPUR tests, respectively, was calculated according to the following equation:

$$Δ Y ( \% ) = ( {Y}_{initial}^{*} - {Y}_{final}^{*} ) / {Y}_{initial}^{*} \times 100 \%$$

The smaller ΔY value, the better DPUR property.

### Durability Test

Blue Paint panels were prepared according to the above steps (i) to (iv), based on blue coating compositions described below. Initial L*ᵢₙᵢₜᵢₐₗ, a*ᵢₙᵢₜᵢₐₗ, and b*ᵢₙᵢₜᵢₐₗ values of the panels were measured by a Spectro-guide Sphere Gloss Portable Spectrophotometers (BYK-Gardner) and recorded as L*ᵢₙᵢₜᵢₐₗ, a*ᵢₙᵢₜᵢₐₗ, and b*ᵢₙᵢₜᵢₐₗ, respectively. These panels were then subjected to outdoor exposure. The exposure direction was 450 south angle. After 9 months of exposure, appearance change of the panels was observed and final L*, a* and b* values were recorded as L*_{final}, a*_{final}, and b*_{final}, respectively. AE values, indicating durability of the samples, were calculated according to the below formula.

$$Δ E = \sqrt{{( {L}_{initial}^{*} - {L}_{final}^{*} )}^{2} + {( {a}_{initial}^{*} - {a}_{final}^{*} )}^{2} + {( {b}_{initial}^{*} - {b}_{final}^{*} )}^{2}}$$

### Mechanical Properties

The mechanical properties including elongation at break and tensile strength were measured by using AI-7000M Universal Testing, according to JG/T 172-2005 Elastomeric Wall Coating standard. A coating composition to be tested was applied onto an exfoliate paper using an applicator to form a first layer with wet film thickness of 1,500 μm. After 24 hours, a second layer of the coating composition was applied on the first layer with wet film thickness of 1,500 μm. After another 24 hours, a third layer of the coating composition was applied on the second layer with wet film thickness of 1,000 μm. The coated paper was dried for 2 days in the CTR (25° C., 50% RH), and then put into an oven at 80° C. for 4 days. The coated paper was taken out from the oven, and then kept in the CTR (25° C., 50% RH) for 2 days. The obtained coating films were peeled off from the exfoliate paper and cut into dumbbell shape by a special knife modal. The films were selected by dry film thickness within the range of 1.0±0.2 mm. The coating films were then evaluated for elongation at break and tensile strength at maximize at room temperature, which are denoted as “RT Elongation” and “RT Tensile strength”, respectively. For low temperature mechanical performance testing, the dried film was put in an environmental box at −10° C. for 30 minutes before testing and the tested elongation at break and tensile strength at maximize are denoted as “LT Elongation” and “LT Tensile strength”, respectively.

### Stability of Aqueous Dispersions

A vinyl siloxane was first mixed with a binder at a predetermined dosage under stirring at 400 revolutions per minute (rpm) at room temperature for 20 minutes to form an aqueous dispersion. 20 ml of the obtained aqueous dispersion were immediately poured into a test tube with a diameter of 1.4 centimeters (cm). The height of the aqueous dispersion in the tube was 13.0 cm, denoted as “original height.” The test tube was stored in an oven at 50° C. for 28 days. Then, the test tube was removed from the oven to observe appearance of the aqueous dispersion in the tube by the naked eye. If phase separation is observed, distance from the observed interface to the top surface of the aqueous dispersion was recorded as “layering thickness.” If the aqueous dispersion shows no observable phase separation or the layering thickness is less than 20% of the original height, after stored at 50° C. for 28 days, both indicating no significant phase separation, storage stability is considered good. Smaller layering thickness indicates better storage stability of the aqueous dispersion.

### DSC

A 5-10 milligram (mg) sample was analyzed in a sealed aluminum pan on a TA Instrument DSC Q2000 fitted with an auto-sampler under nitrogen atmosphere. Tg measurement by DSC was with three cycles including, from −60 to 150° C. at 10° C./min followed by holding for 5 minutes (1^{st} cycle), from 150 to −60° C., 10° C./min (2^{nd} cycle), and from −60 to 150° C., 10° C./min (3^{rd} cycle). Tg was obtained from the 3^{rd} cycle by “half height” method.

### Synthesis of Binder (PD-0)

A monomer emulsion was prepared by mixing butyl acrylate (1159 g), styrene (404 g), acrylic acid (32.4 g), sodium styrene sulfonate (5.8 g), phosphoethyl methacrylate (60% active, 4 g), Silquest A-171 vinyl trimethoxysilane (5 g, Momentive), deionized (DI) water (406 g), and 89 g of an aqueous solution of sodium dodecyl benzene sulfonate (DBS) (19% solids), emulsifying with stirring. Next, 8.8 g of an aqueous solution of DBS (19% solids) and 700 g of DI water were charged to a five liter multi-neck flask fitted with mechanical stirring. The contents of the flask were heated to 90° C. under a nitrogen atmosphere. To the stirred flask, the monomer emulsion (53.7 g), ferrous sulfate (0.025 g) and sodium salt of ethylenediaminetetraacetic (EDTA) (0.13 g) were added followed by a solution of ammonium persulfate (APS) (5.76 g APS dissolved in 15.6 g DI water). The remainder of the monomer emulsion, a solution of APS (2.3 g APS dissolved in 60 g DI water) and a solution of sodium bisulfite (SBS) (2.3 g SBS dissolved in 63 g DI water) were then added to the flask over 120 minutes. The flask temperature was maintained at 87° C. Next, 26 g of DI water was used to rinse the emulsion feed line to the flask. After cooling the contents of the flask, t-butyl hydroperoxide (4.8 g, 70% active), and an aqueous solution of isoascorbic acid (2.3 g isoascorbic acid dissolved in 63 g water) were added to the flask. The contents of the flask were neutralized to a pH of 8.0 with ammonium hydroxide. To the cooled batch, an aqueous solution of TERGITOL 15-s-40 surfactant (11.5 g 15-S-40 dissolved in 12.5 g DI water) was added to the flask, following by a rinse of 5 g of DI water (TERGITOL 15-s-40 fatty alcohol ethoxylate with 40 ethylene oxide is available from The Dow Chemical Company). Then an aqueous solution of 2-Methyl-4-isothiazolin-3-one (MIT) (3.6 g MIT dissolved in 17.4 g DI water) was added to the flask, followed by 0.8 g of Nopco NXZ defoamer (Nopco). The obtained binder (solids: 48.5%) contained a styrene-acrylic emulsion polymer with a Tg of −9° C. as measured by DSC described above.

### Aqueous Dispersions

The aqueous dispersions of Examples (Exs) 1-4, 6-12, and E-F and Comparative (Comp) Exs 5 and 13-14, and Comp Exs A-D were prepared by mixing the above obtained binder (PD-0) with different types of siloxanes, and optionally BzP, at different dosage under stirring (400 rpm) at room temperature for 20 minutes, based on formulations listed in Table 1.

Stability properties of the obtained aqueous dispersions comprising different types of vinyl siloxanes were evaluated and results are given in Table 1. As shown in Table 1, the aqueous dispersions comprising cyclic methylvinyl siloxanes or hydroxy-terminated methylvinyl siloxane at the dosage of 5.0% or lower showed good stability when stored at 50° C. for 28 days (PD-1 and PD-6 to PD-12). The aqueous dispersion comprising the linear siloxane with hydroxyl end groups (PD-1) showed much better stability than that contains the linear siloxane with alkyl end groups (PD-5). Stability properties of the aqueous polymer dispersions dropped significantly when the siloxanes dosage increased to 6.0% (PD-13 and PD-14).

TABLE 1
Compositions and Properties of Aqueous Dispersions

| | Dosage of vinyl siloxane additive¹ | | | | | |
|---|---|---|---|---|---|---|
| | | Hydroxy- | | Methyl- | | |
| | Tetra(dimethyl- | terminated | Cyclic | terminated | | Layering |
| Aqueous | vinylsiloxy) | methylvinyl | methylvinyl | methylvinyl | | Thickness² |
| dispersion | silane | siloxane | siloxane | siloxane | BzP¹ | (cm) |
| Ex 1 (PD-1) | | 1.50% | | | | 2.2 |
| Ex 2 (PD-2) | | 1.50% | | | 0.20% | |
| Ex 3 (PD-3) | | 1.50% | | | 0.50% | |
| Ex 4 (PD-4) | | 2.00% | | | 0.50% | |
| Comp Ex 5 | | | | 1.5% | | 5.2 |
| (PD-5) | | | | | | |
| Ex 6 (PD-6) | | | 1.5% | | | 1.9 |
| Ex 7 (PD-7) | | | 3% | | | 1.2 |
| Ex 8 (PD-8) | | 3% | | | | 1.1 |
| Ex 9 (PD-9) | | | 4% | | | 1.4 |
| Ex 10 (PD-10) | | 4% | | | | 1.2 |
| Ex 11 (PD-11) | | | 5.0% | | | 0.9 |
| Ex 12 (PD-12) | | 5.0% | | | | 0.8 |
| Comp Ex 13 | | | 6.0% | | | 6.4 |
| (PD-13) | | | | | | |
| Comp Ex 14 | | 6.0% | | | | 4.0 |
| (PD-14) | | | | | | |
| Comp Ex A | | | | | 0.50% | |
| (PD-A) | | | | | | |
| Comp Ex B | | | | | 1.00% | |
| (PD-B) | | | | | | |
| Comp Ex C | 1.50% | | | | 0.50% | |
| (PD-C) | | | | | | |
| Comp Ex D | 1.50% | | | | 1.00% | |
| (PD-D) | | | | | | |
| Ex E (PD-E) | | 1.50% | | | 1.00% | |
| Ex F (PD-F) | | | 1.50% | | 1.00% | |

¹by weight based on the solids weight of binder (i.e., the dry weight of the emulsion polymer)
²after storage at 50° C. for 28 days as described in the stability test

### White Coating Compositions

Two groups of coating composition samples, Samples I series and Samples II series, were prepared based on formulations given in Table 2. Types of aqueous dispersions used in preparing Samples I series and Samples II series are given in Tables 4 and 5, respectively. First, water, Natrosol 25HBR, ammonia, propylene glycol, OROTAN™ 963, TRITON EF-106, Nopco NXZ, Ti-Pure R-706 TiO₂, CC-1000 and CC-700 were mixed and ground under 2,500 rpm agitation for about 30 minutes to form the grinds. Then, the binder or an aqueous dispersion comprising the binder and additives, Tego 825, ACRYSOL™ TT-935, ammonia, and water were added to the grinds and further stirred for 20 minutes at 800 rpm to give white coating compositions (OROTAN and ACRYSOL are trademarks of The Dow Chemical Company). Coating compositions described herein refer to white coating compositions, unless otherwise stated. The obtained coating compositions were evaluated for properties according to the test methods described above. When preparing paint panels for the tests, the exterior primer composition used was prepared according to the same procedure as preparing the coating compositions above, based on the primer composition given in Table 3.

TABLE 2
White coating compositions (White Paints)

| Coating composition | Supplier | gram |
|---|---|---|
| Grind | | |
| DI Water | | 138.0 |
| Natrosol 250HBR hydroxyethyl | Ashland Aqualon Company | 1.6 |
| cellulose | | |
| Ammonia (28%) | Sinopharm Chemical | 0.1 |
| | Reagent Co., Ltd. | |
| Propylene Glycol | The Dow Chemical Company | 15.9 |
| OROTAN 963 polyacid | The Dow Chemical Company | 6.4 |
| dispersant (35%) | | |
| TRITON EF-106 surfactant | The Dow Chemical Company | 1.6 |
| Nopco NXZ defoamer | NOPCO | 1.0 |
| Ti-Pure R-706 (TiO2) | Chemours | 159.0 |
| CC-1000 (calcium carbonate, | Guangfu Building Materials | 106.0 |
| 1000 mesh) | Group (China) | |
| CC-700 (calcium carbonate, | Guangfu Building Materials | 159.0 |
| 700 mesh) | Group (China) | |
| Grind Sub-total | | 588.6 |
| LetDown | | |
| Aqueous Dispersion (binder and | | 378.9 |
| additives if any) as prepared | | |
| Tego 825 defoamer | Evonik | 1.0 |
| ACRYSOL TT-935 (1:1) HASE | The Dow Chemical Company | 15.0 |
| thickener | | |
| Ammonia (28%) | Sinopharm Chemical | 3.3 |
| | Reagent Co., Ltd. | |
| Water | | 13.4 |
| Total | | 1000.2 |

*Total PVC of paint formulations: 44.14%, Volume Solids: 44.52%, Weight Solids: 60.78%

TABLE 3
Exterior Primer Composition

| Coating composition | Supplier | gram |
|---|---|---|
| Grind | | |
| DI Water | | 160.0 |
| Propylene glycol | The Dow Chemical Company | 15.0 |
| CELLOSIZE ™ QP 15000H | The Dow Chemical Company | 2.0 |
| hydroxyethyl cellulose | | |
| Ammonia (28%) | Sinopharm Chemical | 1.5 |
| | Reagent Co., Ltd. | |
| OROTAN 963 polyacid | The Dow Chemical Company | 7.0 |
| dispersant (35%) | | |
| TRITON EF-106 surfactant | The Dow Chemical Company | 2.0 |
| Disperlair CF-246 defoamer | NOPCO | 1.5 |
| Lomon R-996 TiO2 | Lomon | 30.0 |
| CC-800 calcium carbonate | Guangfu Building Materials | 280.0 |
| (800 mesh) | Group (China) | |
| Talc 800 Talc (800 mesh) | Guangfu Building Materials | 100.0 |
| | Group (China) | |
| Grind Sub-total | | 599.0 |
| Letdown | | |
| PRIMAL ™ DC-420 (styrene- | The Dow Chemical Company | 230.0 |
| acrylic emulsion) | | |
| Texanol coalescent | Eastman | 23.0 |
| Disperlair CF-246 defoamer | NOPCO | 1.5 |
| ACRYSOL TT-935 HASE | The Dow Chemical Company | 4.0 |
| thickener | | |
| Water | | 141.0 |
| KATHON ™ LXE biocide | The Dow Chemical Company | 2.0 |
| Total | | 1000.5 |

* CELLOSIZE, PRIMAL, and KATHON are trademarks of The Dow Chemical Company.

The obtained coating compositions of Samples I series were evaluated according to the test method described above and results of lab DPUR performance are summarized in Table 4. As shown in Table 5, the coating composition of Coating 1-E showed the lowest ΔY value, that is, the best DPUR performance, as compared to the coating composition of Coating 1-. Addition of cyclic methylvinyl siloxane (Coating 1-F) also improved DPUR performance as compared to the coating composition of Coating 1-B. In contrast, addition of tetra(dimethylvinylsiloxy)silane (a branched silane) had no improvement on DPUR performance (Coating 1-C and Coating 1-D).

TABLE 4
Samples I formulations and lab DPUR results

| | | Vinyl siloxane additive* | | | | |
|---|---|---|---|---|---|---|
| | | | Hydroxy- | | | |
| | | Tetra(dimethyl- | terminated | Cyclic | | Lab |
| Coating | Aqueous | vinylsiloxy) | methylvinyl | methylvinyl | | DPUR |
| composition | dispersion | silane | siloxane | siloxane | BzP* | (ΔY, %) |
| Coating 1-A | PD-A | | | | 0.50% | 25.84 |
| Coating 1-B | PD-B | | | | 1.00% | 22.11 |
| Coating 1-C | PD-C | 1.50% | | | 0.50% | 27.58 |
| Coating 1-D | PD-D | 1.50% | | | 1.00% | 22.36 |
| Coating 1-E | PD-E | | 1.50% | | 1.00% | 15.74 |
| Coating 1-F | PD-F | | | 1.50% | 1.00% | 20.62 |

*by weight based on the solids weight of binder (i.e., the dry weight of the emulsion polymer)

Table 5 gives types of aqueous dispersions used in preparing coating compositions of Samples II series and DPUR and mechanical properties of the resultant coating films. As shown in Table 5, the inventive coating compositions comprising hydroxy-terminated methylvinyl siloxane provided improved DPUR properties, as indicated by ΔY values at least 22% lower (lab DPUR testing) or at least 16% lower (outdoor DPUR testing) than that of Coating 0. In addition, higher loading of BzP was helpful to further improve DPUR performance of coating films comprising thereof (Coating 3). All inventive coating compositions (Coating 1 through Coating 4) provided comparable elongation and tensile strength properties as the coating composition of Coating 0.

TABLE 5
Samples II formulations and Lab DPUR and mechanical properties

| Coating composition | Coating 0 | Coating 1 | Coating 2 | Coating 3 | Coating 4 |
|---|---|---|---|---|---|
| Aqueous Dispersion | PD-0 | PD-1 | PD-2 | PD-3 | PD-4 |
| Hydroxy-terminated | 0 | 1.50% | 1.50% | 1.50% | 2.00% |
| methylvinyl siloxane)¹ | | | | | |
| BzP* | 0 | 0 | 0.20% | 0.50% | 0.50% |
| Lab DPUR (ΔY, %) | 38.45 | 15.04 | 15.56 | 12.62 | 10.08 |
| Outdoor DPUR² (ΔY, %) | 38.6 | 16.7 | NA | 16.1 | 21.9 |
| RT Elongation (%) | 389 | 414 | 330 | 383 | 395 |
| RT Tensile strength (MPa) | 2.8 | 2.7 | 2.9 | 2.6 | 2.6 |
| LT Elongation (%) | 53 | 70 | 57 | 51 | 65 |
| LT Tensile strength (MPa) | 12.2 | 11.0 | 11.8 | 10.7 | 10.8 |

¹% by solids weight based on the solids weight of the binder
²Outdoor DPUR after 9-month outdoor exposure

### Blue Coating Compositions

Additional 2%, by weight based on the total weight of each white coating composition, of organic phthalo blue colorant (888-7214 COLORTREND PHTHALO BLUE E) was added to the coating compositions of Coating 0, Coating 1, Coating 3, and Coating 4, respectively, to obtain Blue Coating 0, Blue Coating 1, Blue Coating 3, and Blue Coating 4. Outdoor durability properties of these blue coating compositions were evaluated based on the test method described above. As shown in Table 6, the inventive coating compositions also showed improved color retention properties after outdoor exposure for 9 months, for example, ΔE of blue paint panels of Blue Coating 3 and Blue Coating 4 both decreased about 8 units, indicating better outdoor durability, as compared to that of Blue Coating 0.

TABLE 6
Color change after 9-month outdoor exposure (Blue paints)

| Blue Coating | Aqueous | Hydroxy-terminated | | |
|---|---|---|---|---|
| Composition | Dispersion | methylvinyl siloxane | BzP | delta E |
| Blue Coating 0 | PD-0 | | | 16.6 |
| Blue Coating 1 | PD-1 | 1.50% | | 12.0 |
| Blue Coating 3 | PD-3 | 1.50% | 0.50% | 8.8 |
| Blue Coating 4 | PD-4 | 2.00% | 0.50% | 8.5 |

What is claimed is:

1. An aqueous dispersion, comprising:
(a) an emulsion polymer,
(b) from 0.1% to 5.5% of a siloxane selected from a linear siloxane, a cyclic siloxane, and mixtures thereof, by weight based on the dry weight of the emulsion polymer, wherein the linear siloxane has the following formula (I), 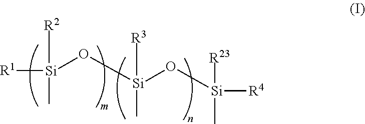
where R¹ and R⁴ are independently selected from —OH, —NH₂, —NHR⁵, and —NR⁵₂, wherein each R⁵ is independently a C₁₋₅ alkyl group; each R² is independently a C₂₋₁₀ linear or branched alkenyl group with one to three double bonds; each R³ is independently selected from a C₁₋₆ linear or branched alkyl group; R²³ is a C₂₋₁₀ linear or branched alkenyl group with one to three double bonds or a C₁₋₆ linear or branched alkyl group; m is an integer of from 2 to 40; and n is an integer of from 0 to 20;
wherein the cyclic siloxane has the following formula (II), 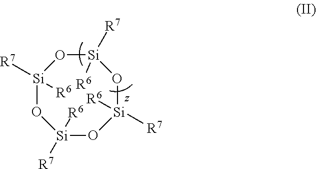
where each R⁶ is independently selected from hydrogen and a C₁₋₆ linear or branched alkyl group; each R⁷ is independently a C₂₋₁₀ linear or branched alkenyl group with one to three double bonds; and z is an integer of from 1 to 20; and
(c) from zero to 3% of a photocrosslinker, by weight based on the dry weight of the emulsion polymer.

2. The aqueous dispersion of claim 1, wherein, in formula (I), R¹ and R⁴ are independently selected from —OH and —NH₂, and m is from 4 to 16.

3. The aqueous dispersion of claim 1, wherein the cyclic siloxane is selected from the group consisting of tetramethyltetravinylcyclotetrasiloxane, tetraethyltetravinylcyclotetrasiloxane, tetrapropyltetravinylcyclotetrasiloxane, tetrabutyltetravinylcyclotetrasiloxane, tetrahexyltetravinylcyclotetrasiloxane, and mixtures thereof.

4. The aqueous dispersion of claim 1, wherein the photocrosslinker is selected from the group consisting of a benzophenone derivative, a benzotriazole derivative, an acylphosphine oxide, a bisacylphosphine oxide, and mixtures thereof.

5. The aqueous dispersion of claim 1, comprising from 1.0% to 5.0% of the siloxane, by weight based on the dry weight of the emulsion polymer.

6. The aqueous dispersion of claim 1, further comprising a nonionic surfactant.

7. The aqueous dispersion of claim 6, wherein the nonionic surfactant is present in an amount of from 0.1% to 5% by weight based on the dry weight of emulsion polymer.

8. The aqueous dispersion of claim 1, wherein the photocrosslinker is present in an amount of less than 0.6% by weight based on the dry weight of the emulsion polymer.

9. The aqueous dispersion of claim 1, wherein the emulsion polymer is an acrylic polymer, a styrene-acrylic polymer, or a combination thereof.

10. The aqueous dispersion of claim 1, wherein the emulsion polymer has a Tg of from −40 to 10° C.

11. A process of preparing the aqueous dispersion of claim 1, comprising: admixing an emulsion polymer with from 0.1% to 5.5% of a siloxane selected from a linear siloxane, a cyclic siloxane, and mixtures-thereof, and from zero to 3% of a—photocrosslinker, by weight based on the dry weight—of the emulsion polymer;
wherein the linear siloxane has the following formula (I), 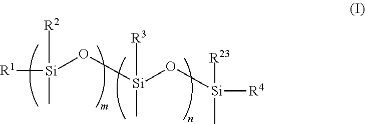
where R¹ and R⁴ are independently selected from —OH, —NH₂, —NHR⁵, and —NR⁵₂, wherein each R⁵ is independently a C₁₋₅ alkyl group; each R² is independently a C₂₋₁₀ linear or branched alkenyl group with one to three double bonds; each R³ is independently a C₁₋₆ linear or branched alkyl group; R²³ is a C₂₋₁₀ linear or branched alkenyl group with one to three double bonds or a C₁₋₆ linear or branched alkyl group; m is an integer of from 2 to 40; and n is an integer of from 0 to 20;
wherein the cyclic siloxane has the following formula (II), 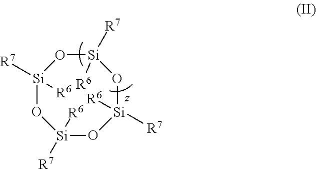
where each R⁶ is independently selected from hydrogen and a C₁₋₆ linear or branched alkyl group; each R⁷ is independently a C₂₋₁₀ linear or branched alkenyl group with one to three double bonds, and z is an integer of from 1 to 20.

12. An aqueous coating composition, comprising the aqueous dispersion of claim 1 and a pigment and/or an extender.
